(19) United States
(12) Patent Application Publication
(10) Pub. No.: US 2019/0229406 A1
(43) Pub. Date: Jul. 25, 2019

(54) ANTENNA DEVICE FOR MOBILE TERMINAL, AND MOBILE TERMINAL

(71) Applicant: BYD COMPANY LIMITED, Shenzhen, Guangdong (CN)

(72) Inventors: Qinyang CAI, Shenzhen (CN); Munyong CHOI, Shenzhen (CN); Mingqian SHAO, Shenzhen (CN); Faping WANG, Shenzhen (CN)

(73) Assignee: BYD COMPANY LIMITED, Shenzhen, Guangdong (CN)

(21) Appl. No.: 16/337,296

(22) PCT Filed: Sep. 27, 2017
(86) PCT No.: PCT/CN2017/103666

§ 371 Date: Mar. 27, 2019

(30) Foreign Application Priority Data
Sep. 29, 2016 (CN) 201610865234.1

(51) Int. Cl. H01Q 1/24; H01Q 5/10; H01Q 5/307; H01Q 5/20

(52) U.S. Cl. CPC H01Q 1/243; H01Q 5/20; H01Q 5/307; H01Q 5/10

(57) ABSTRACT

The present disclosure discloses a mobile terminal and an antenna device for same. The antenna device includes: a primary antenna and a first metal component. The primary antenna is disposed on the bottom of a mobile terminal and includes: a first antenna branch; a second antenna branch; and a first feed point. The first feed point is connected to a first end of the first antenna branch and a first end of the second antenna branch. The first feed point is connected to a mainboard of the mobile terminal. The first metal component is located on the bottom of the mobile terminal and includes a first metal segment, a second metal segment, and a third metal segment. The first metal segment, the second metal segment, and the third metal segment are sequentially arranged in a horizontal direction. The first metal segment and the third metal segment are connected to a metal rear case of the mobile terminal. The second metal segment has a connection point which is connected to a second end of the second antenna branch.

### CROSS-REFERENCE TO RELATED APPLICATIONS

This application is the U.S. national phase entry of PCT Application No. PCT/CN2017/103666, filed Sep. 27, 2017, which is based upon and claims priority to Chinese Patent Application No. 201610865234.1, filed Sep. 29, 2016, the entire contents of which are incorporated herein by reference.

### FIELD

The present disclosure relates to the field of communications technologies, and in particular, to an antenna device for a mobile terminal, and a mobile terminal.

### BACKGROUND

In the related art, a metal antenna used for a mobile terminal has a disadvantage of being incapable of covering 4G LTE frequency bands and has two feed points. During antenna design, isolation needs to be considered, and because the two radiators are very close to each other, the isolation cannot be ensured. Moreover, such a metal antenna occupies a metal rear case of the entire mobile terminal, and consequently there is no location on the metal rear case to design another antenna.

### SUMMARY

An objective of the present disclosure is to at least resolve one of the technical problems in the related art to some extent. To this end, an objective of the present disclosure is to propose an antenna device for a mobile terminal where the antenna device may cover all frequency bands of 2G/3G/4G.

Another objective of the present disclosure is to propose a mobile terminal.

To achieve the foregoing objectives, an antenna device for a mobile terminal proposed in an exemplary embodiment includes: a primary antenna, where the primary antenna is disposed on the bottom of a mobile terminal. The primary antenna includes: a first antenna branch and a second antenna branch; a first feed point, where the first feed point is connected to a first end of the first antenna branch and a first end of the second antenna branch, the first feed point is connected to a mainboard of the mobile terminal; a first metal component located on the bottom of the mobile terminal, where the first metal component includes a first metal segment, a second metal segment, and a third metal segment, where the first metal segment, the second metal segment, and the third metal segment are isolated from each other and sequentially arranged in a horizontal direction. Each of the first metal segment and the third metal segment is connected to a metal rear case of the mobile terminal. The second metal segment has a connection point, and the connection point is connected to a second end of the second antenna branch.

According to an exemplary embodiment, the first feed point of the primary antenna is connected to the first antenna branch and the second antenna branch of the primary antenna, the first feed point is connected to the mainboard of the mobile terminal, and the second end of the second antenna branch is connected to the first metal component. Therefore, all frequency bands of 2G/3G/4G, including low frequencies and high frequencies of LTE/GSM/CDMA/UMTS, may be covered by using one primary antenna. Therefore, all frequency bands for global mobile phone calls may be covered, the frequency bands are wide, and the radiation efficiency is high. Moreover, for one primary antenna, the isolation problem does not need to be considered, and the costs may be further reduced.

To achieve the foregoing objectives, an embodiment of another aspect of the present disclosure proposes a mobile terminal, including the antenna device according to the first aspect.

According to the mobile terminal proposed in this exemplary embodiment, the performance of the mobile terminal may be improved by using the antenna device according to the foregoing embodiment.

### BRIEF DESCRIPTION OF THE DRAWINGS

FIG. 1 is a top view of an antenna device for a mobile terminal according to an exemplary embodiment where a metal rear case is included;

FIG. 2a is a schematic structural diagram of a primary antenna according to an exemplary embodiment;

FIG. 2b is an amplified schematic diagram of a first antenna branch in FIG. 2a;

FIG. 2c is an amplified schematic diagram of a second antenna branch in FIG. 2a;

FIG. 3 is a top view of an antenna device for a mobile terminal according to an exemplary embodiment where no metal rear case is included;

FIG. 4 is a circuit principle diagram of a matching and switching circuit according to an exemplary embodiment;

FIG. 5a is a simulation curve diagram of return losses of a primary antenna in a state 1, a state 2, and a state 3 according to an exemplary embodiment;

FIG. 5b is an actual test curve diagram of return losses of a primary antenna in a state 1, a state 2, a state 3, and a state 4 according to an exemplary embodiment;

FIG. 6a is a comparison diagram of a simulation curve and an actual test curve of efficiency of a primary antenna in a state 1 according to an exemplary embodiment;

FIG. 6b is a comparison diagram of a simulation curve and an actual test curve of efficiency of a primary antenna in a state 2 according to an exemplary embodiment;

FIG. 6c is a comparison diagram of a simulation curve and an actual test curve of efficiency of a primary antenna in a state 3 according to an exemplary embodiment;

FIG. 7 is a comparison diagram of a simulation curve and an actual test curve of efficiency of a multiple-input multiple-output (MIMO) antenna according to an exemplary embodiment;

FIG. 8 is a comparison diagram of a simulation curve and an actual test curve of efficiency of a Global Positioning System (GPS) and Bluetooth (BT)/Wireless-Fidelity (WiFi) two-in-one antenna according to an exemplary embodiment; and

FIG. 9 is a comparison diagram of a simulation curve and an actual test curve of efficiency of a 5G WiFi antenna according to an exemplary embodiment.

### DETAILED DESCRIPTION

The following describes exemplary embodiments in detail. Examples of the embodiments are shown in the accompanying drawings. The same or similar elements and the elements having same or similar functions are denoted by like reference numerals throughout the descriptions. The embodiments described below with reference to the accompanying drawings are exemplary, aim to explain the disclosure, but cannot be understood as a limitation on the disclosure.

An antenna device for a mobile terminal according to an exemplary is described below with reference to the accompanying drawings. The antenna device is applicable to mobile terminals such as a mobile phone and a tablet computer and may cover all 4G frequency bands for mobile phones, including all low frequencies and high frequencies of Long Term Evolution (LTE)/Global System for Mobile Communications (GSM)/Code Division Multiple Access (CDMA)/Universal Mobile Telecommunications System (UMTS). The high frequencies of LTE may be all LTE frequency bands operating within a range of 1710 MHz to 2690 MHz.

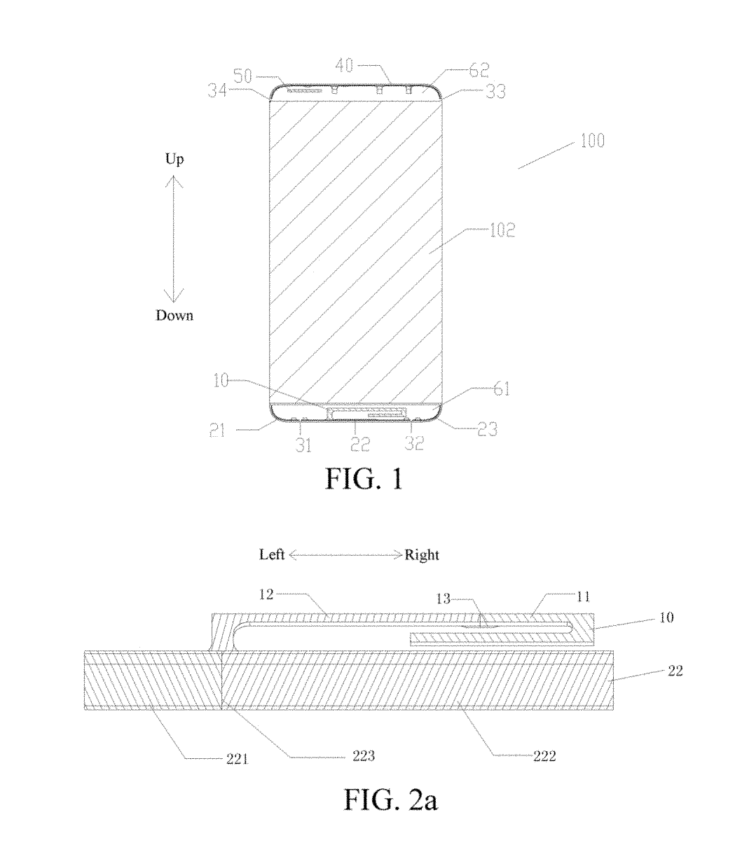

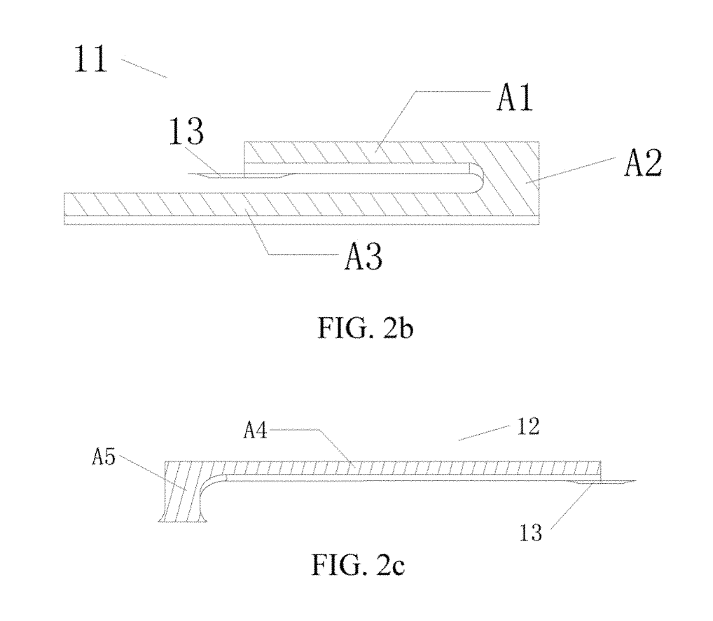

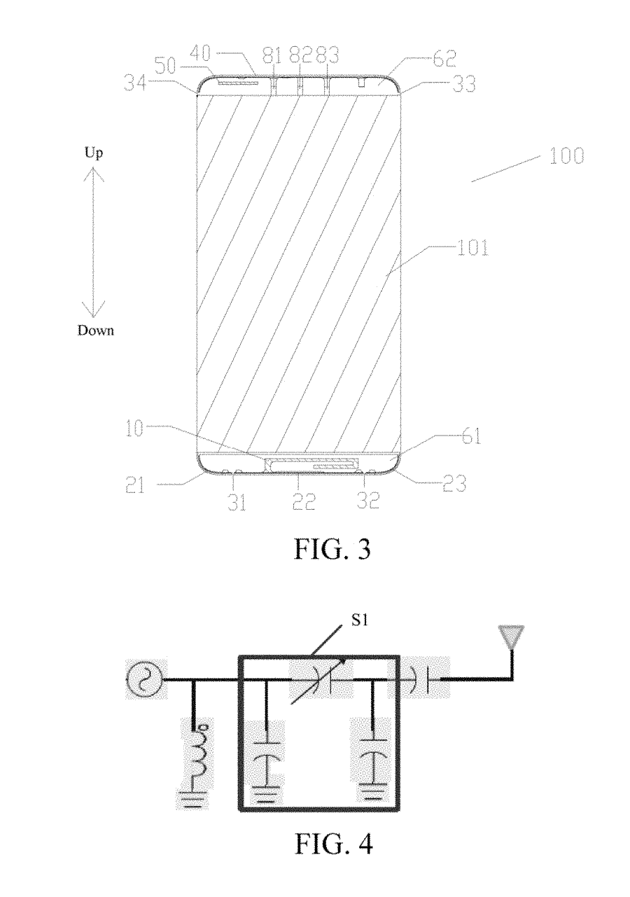

The antenna device according to this embodiment in FIG. 1, FIG. 2a, and FIG. 3 includes: a primary antenna 10 and a first metal component.

The primary antenna 10 is disposed on the bottom of a mobile terminal 100, and the primary antenna 10 includes: a first antenna branch 11, a second antenna branch 12, and a first feed point (not shown). The first feed point is connected to a first end of the first antenna branch 11 and a first end of the second antenna branch 12, and the first feed point is connected to a mainboard 101 of the mobile terminal 100. Specifically, the first end of the first antenna branch 11 is connected to the first end of the second antenna branch 12, a connection location is provided with a first connection point 13, the first feed point may be located on the mainboard 101, and the first feed point may be connected to the first connection point 13 by using an elastic sheet.

The first metal component is located on the bottom of the mobile terminal 100, and the first metal component may also be used as a metal bezel located on the bottom of the mobile terminal 100. The first metal component includes a first metal segment 21, a second metal segment 22, and a third metal segment 23. The first metal segment 21, the second metal segment 22, and the third metal segment 23 are isolated from each other and sequentially arranged in a horizontal direction. To be specific, the first metal segment 21 and the third metal segment 23 are respectively located at a left end and a right end of the second metal segment 22. Moreover, each of the first metal segment 21 and the third metal segment 23 is connected to a metal rear case 102 of the mobile terminal 100, the second metal segment 22 has a second connection point 223, and the second connection point 223 is connected to a second end of the second antenna branch 12.

A lower portion of the metal rear case 102 of the mobile terminal 100 has a first non-metal area 61, and the primary antenna 10 may be disposed in the first non-metal area 61, where the first non-metal area 61 may be filled with a medium through Plastic Metal Hybrid (PMH).

It should be noted that, the second metal segment 22 is connected to the primary antenna 10, and therefore the second metal segment 22 may be used as a part of the primary antenna 10. In other words, an antenna covering all frequency bands of 2G/3G/4G includes two parts, where one part is the second metal segment 22 located on the bottom of the mobile terminal 100, and the other part is an added antenna branch. The antenna branch is divided by the first connection point 13 into two parts, a part on the right of the first connection point 13 is the first antenna branch 11, and a part on the left of the first connection point 13 is the second antenna branch 12.

According to an exemplary embodiment, the second metal segment 22 has a first metal sub-segment 221 and a second metal sub-segment 222, and the second connection point 223 is disposed between the first metal sub-segment 221 and the second metal sub-segment 222. That is to say, the second metal segment 22 is divided by the second connection point 223 into two parts, that is, the first metal sub-segment 221 and the second metal sub-segment 222.

The first antenna branch 11 generates a frequency band of 2300 to 2690 MHz; the second antenna branch 12 generates a frequency band of 699 to 960 MHz in combination with the second metal sub-segment 222; and the second antenna branch 12 generates a frequency band of 1710 to 2170 MHz in combination with the first metal sub-segment 221.

The primary antenna 10 is a monopole antenna. The primary antenna 10 may generate the following frequency bands by using a matching and switching circuit shown in FIG. 4: the second antenna branch 12 plus the second metal sub-segment 222 as an antenna branch generates low-frequency resonance, and may cover low frequency bands including 699 to 960 MHz of LTE by using the matching and switching circuit; the second antenna branch 12 plus the first metal sub-segment 221 as an antenna branch generates intermediate-high-frequency resonance, and may cover frequency bands of 1710 to 2170 MHz by using the matching and switching circuit; and the first antenna branch 11 generates high-frequency frequency bands, and may cover frequency bands of 2300 to 2690 MHz by using the matching and switching circuit. Therefore, the primary antenna 10 may cover frequency bands of 699 to 960 MHz, that is, LTE low-frequency frequency bands and GSM 850/900, and high-frequency frequency bands of 1710 to 2690 MHz, that is, GSM/CDMA/UMTS frequency bands.

The matching and switching circuit may be made to operate in different states by changing a matching value of the matching and switching circuit, thereby implementing frequency band switching. To be specific, as shown in FIG. 4, different capacitance values may be selected by switching a switch S1, to implement different matching circuits, and further implement coverage in different frequency bands. For example, by selecting three different capacitance values of a variable capacitance, the matching and switching circuit may enable the antenna to operate in the following three states to implement coverage in all frequency bands:

When the matching and switching circuit operates in a state 1, frequency bands of 699 to 790 MHz, and all high frequencies of 1710 to 2170 MHz and 2300 to 2690 MHz are covered.

When the matching and switching circuit operates in a state 2, frequency bands of 790 to 894 MHz are covered.

When the matching and switching circuit operates in a state 3, frequency bands of 880 to 960 MHz are covered.

Further, the structure of the first antenna branch 11 and the structure of the second antenna branch 12 are described with reference to an embodiment in FIG. 2a to FIG. 2c.

As shown in FIG. 2a and FIG. 2b, the first antenna branch 11 includes: a first structure A1, a second structure A2, and a third structure A3. The first structure A1 is parallel to the first metal component, and a first end of the first structure A1 is connected to the first feed point. A first end of the second structure A2 is connected to a second end of the first structure A1. The third structure A3 is parallel to the first structure A1, where a first end of the third structure A3 is connected to a second end of the second structure A2, and the length of the third structure A3 is greater than the length of the first structure A1.

As shown in FIG. 2a and FIG. 2c, the second antenna branch 12 includes: a fourth structure A4 and a fifth structure A5, where the fourth structure A4 is parallel to the first metal component, and a first end of the fourth structure A4 is connected to the first feed point. A first end of the fifth structure A5 is connected to a second end of the fourth structure A4, and a second end of the fifth structure A5 is connected to the second connection point 223.

In a specific embodiment, the second structure A2 may be perpendicular to the first structure A1, the second structure A2 may be further perpendicular to the third structure A3, and the fourth structure A4 may also be perpendicular to the fifth structure A5.

As shown in FIG. 2a to FIG. 2c, an antenna branch is divided into two parts on the first connection point 13. A part on the right of the first connection point 13 forms the first antenna branch 11, and the part is first arranged parallel to the second metal segment 22, then vertically bent downward, and finally bent to the left to be arranged parallel to the second metal segment 22. A part on the left of the first connection point 13 forms the second antenna branch 12, the part is arranged parallel to the second metal segment 22 and then bent downward by 90 degrees, and the second antenna branch 12 is connected to the second metal segment 22.

Therefore, the primary antenna 10 is simple in structure and easy in implementation.

According to a specific embodiment, the primary antenna 10 may be manufactured through the use of Computer Numerical Control (CNC).

According to an exemplary embodiment, a first slot 31 is defined between the first metal segment 21 and the second metal segment 22, and a second slot 32 is defined between the second metal segment 22 and the third metal segment 23. Therefore, the second metal segment 22 is isolated from the metal rear case 102 by using the first slot 31 and the second slot 32, that is, the second metal segment 22 is not connected to the metal rear case 102. In this way, a metal bezel is broken by using the first slot 31 and the second slot 32, and then a metal bezel located on the bottom of the mobile terminal 100 is used as an antenna.

The first slot 31 and the second slot 32 may be filled with a plastic composite by using a PMH technology.

Further, as shown in FIG. 1, the antenna device for a mobile terminal further includes: a second metal component 40, where the second metal component 40 is located on the top of the mobile terminal 100, the second metal component 40 may also be used as a metal bezel located on the top of the mobile terminal 100, and the second metal component 40 is isolated from the metal rear case 102 by using a third slot 33 and a fourth slot 34. To be specific, the second metal component 40 is not connected to the metal rear case 102. In this way, a metal bezel is broken by using the third slot 33 and the fourth slot 34, and then a metal bezel located on the top of the mobile terminal 100 is used as an antenna.

The third slot 33 and the fourth slot 34 may be filled with a plastic composite by using the PMH technology.

Further, the second metal component 40 forms a MIMO antenna. As shown in FIG. 3, grounding points of the MIMO antenna and the mainboard 101 are 81, 82, and 83.

That is to say, a MIMO antenna that is a diversity antenna may be designed by using the second metal component 40, and by using the second metal component 40, the MIMO antenna may cover frequency bands of 728 to 960 MHz and 1805 to 2690 MHz.

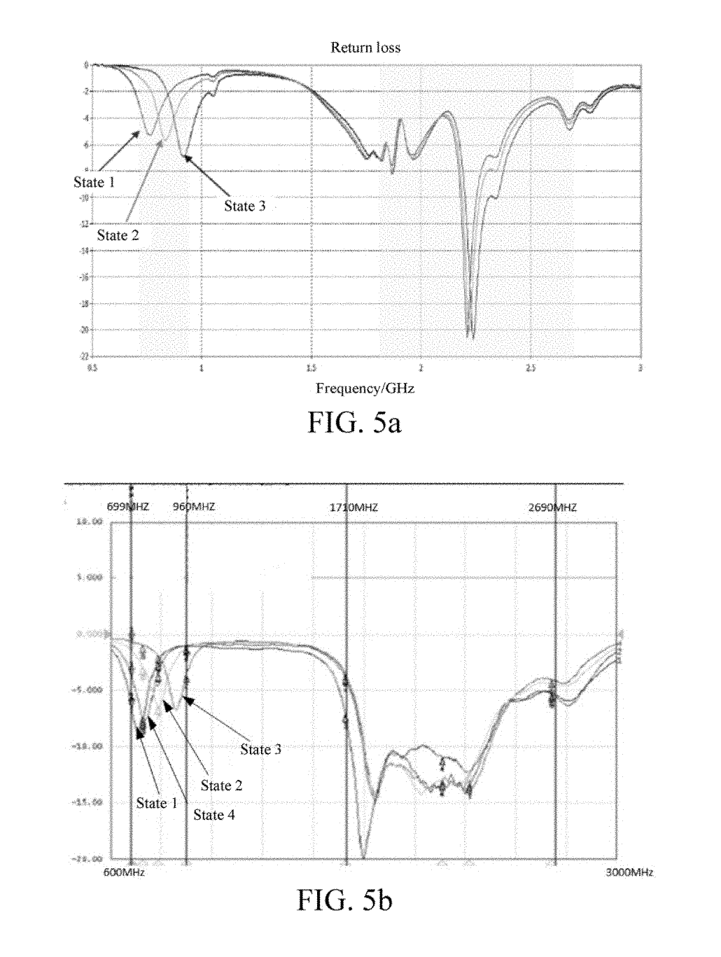

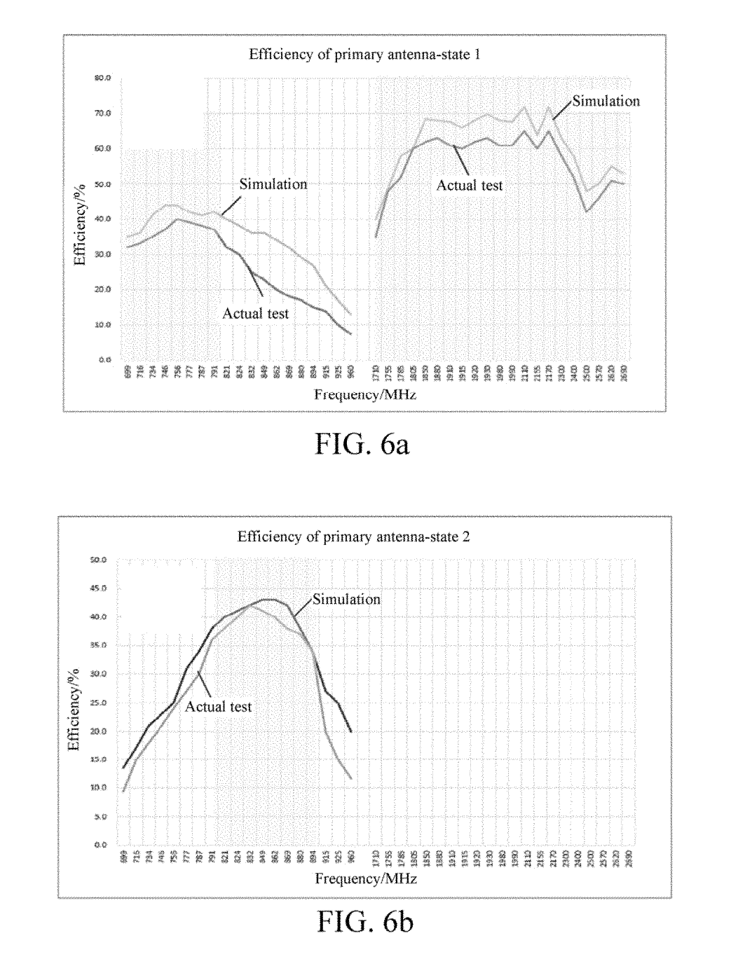

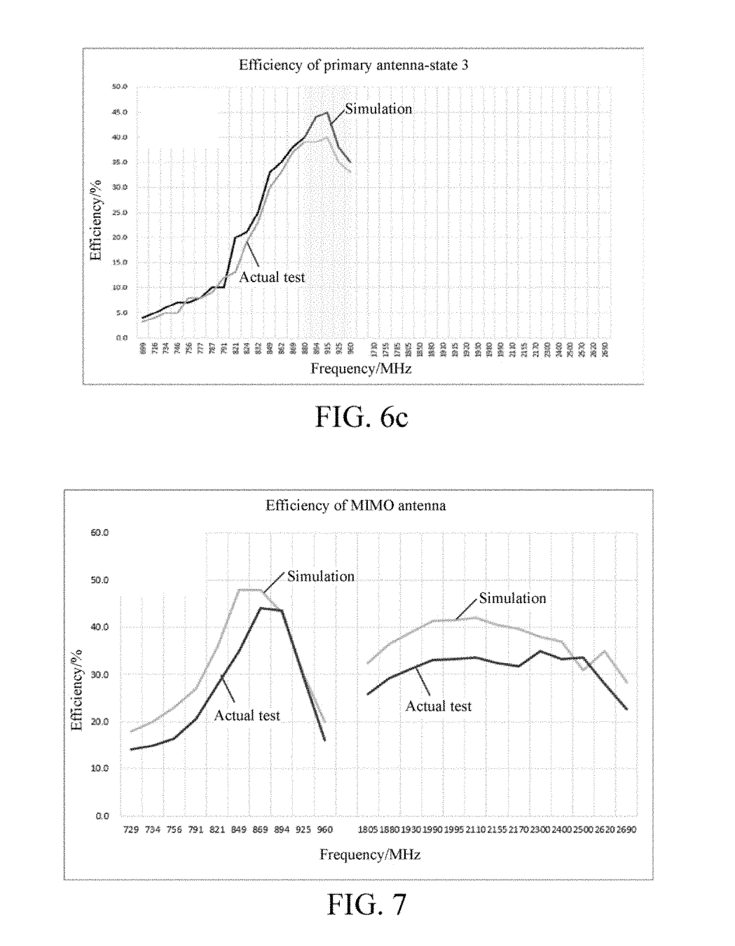

Further, according to some exemplary embodiments as shown in FIG. 1, FIG. 5a, and FIG. 6, the antenna device for a mobile terminal further includes: a first antenna 50, where the first antenna 50 is located on the top of the mobile terminal 100. The first antenna 50 has a second feed point, and the second feed point is connected to the mainboard 101. More specifically, an upper portion of the metal rear case 102 of the mobile terminal 100 has a second non-metal area 62, and the first antenna 50 may be disposed in the second non-metal area 62, where the second non-metal area 62 may be filled with an insulation medium by using the PMH technology.

The first antenna 50 may be a GPS and BT/WiFi two-in-one antenna.

That is to say, a GPS and a 2G BT/WiFi antenna may be designed as a two-in-one antenna, where the GPS includes frequency bands of a Beidou satellite. The first antenna 50 may be located in the second non-metal area 62, the first antenna 50 may be implemented similar to the primary antenna 10, that is, the second feed point may be located on the mainboard 101, and the second feed point may be connected to the first antenna 50 by using an elastic sheet. The first antenna 50 may cover frequency bands of 1550 to 1620 MHz and 2400 to 2484 MHz.

According to an exemplary embodiment, the first antenna 50 may be manufactured in a manner the same as that of the primary antenna 10, that is, the first antenna 50 may be manufactured by using a CNC process.

Additionally, according to some exemplary embodiments, the antenna device for a mobile terminal further includes: a second antenna, where the second antenna is disposed on the mainboard 101. The second antenna may be a WiFi antenna operating in a frequency band of 5150 to 5825 MHz.

That is to say, the second antenna, that is a 5G WiFi antenna, covers high frequency bands of 5150 to 5825 MHz of WiFi. The second antenna is independently disposed on the mainboard 101 and is a printed circuit board (PCB) antenna.

In an exemplary embodiment, the tail end of the second antenna may face toward the fourth slot 34.

In an exemplary embodiment, each of the primary antenna 10, the first antenna 50, and the second antenna may be made of a metal material.

As described above, the primary antenna 10 covering all frequency bands of LTE, the diversity antenna, that is, the MIMO antenna, and the GPS and BT/WiFi two-in-one antenna are disposed in the antenna device according to this embodiment of the present disclosure, and wide frequency bands are covered.

Additionally, the antenna device according to this exemplary embodiment may be simulated and actually tested, so as to verify feasibility of the antenna device. Simulation may be performed through CST2013.

### Exemplary Embodiment 1

Return losses of the primary antenna 10 respectively in a state 1, a state 2, and a state 3 are simulated and actually tested. FIG. 5a is a simulation curve diagram of return losses of the primary antenna 10 in the state 1, the state 2, the state 3, and a state 4, and FIG. 5b is an actual test curve diagram of return losses of the primary antenna 10 in the state 1, the state 2, and the state 3 in a case of switching to three different matching circuits by using a switch S1, where the state 4 is an original state in which no matching circuit is accessed. As is illustrated in FIG. 5a and FIG. 5b it is verified through simulation and actual test that the implementation of the primary antenna 10 is feasible, and a simulation curve is relatively highly consistent with an actual test curve. It may be seen from FIG. 5b that, by introducing the matching circuit switched by the switch S1, the frequency band range covered by the antenna is wider than that in the initial state.

### Exemplary Embodiment 2

Efficiency of the primary antenna 10 respectively in a state 1, a state 2, and a state 3 is simulated and actually tested. FIG. 6a is a comparison diagram of a simulation curve and an actual test curve of efficiency of the primary antenna 10 in the state 1, FIG. 6b is a comparison diagram of a simulation curve and an actual test curve of efficiency of the primary antenna 10 in the state 2, and FIG. 6c is a comparison diagram of a simulation curve and an actual test curve of efficiency of the primary antenna 10 in the state 3. As is illustrated in FIG. 6a to FIG. 6c, it is verified through simulation and actual test that the implementation of the primary antenna 10 is feasible, and a simulation curve is relatively highly consistent with an actual test curve.

### Embodiment 3

Efficiency of the MIMO antenna, that is, the diversity antenna is simulated and actually tested. FIG. 7 is a comparison diagram of a simulation curve and an actual test curve of efficiency of the MIMO antenna. As is illustrated in FIG. 7, it is verified through simulation and actual test that the implementation of the MIMO antenna is feasible, and a simulation curve is relatively highly consistent with an actual test curve.

### Exemplary Embodiment 4

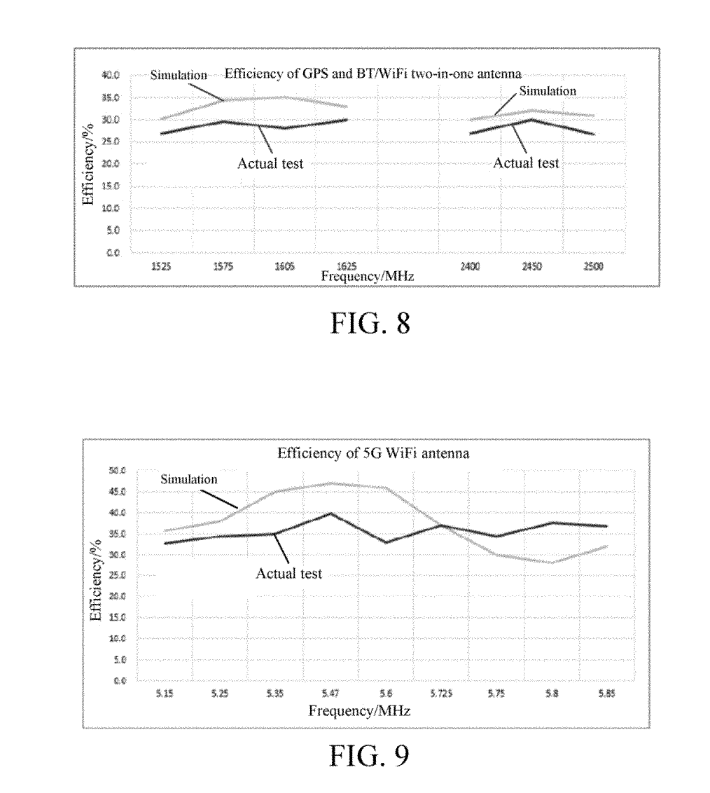

Efficiency of the first antenna 50, that is, the GPS and BT/WiFi two-in-one antenna is simulated and actually tested. FIG. 8 is a comparison diagram of a simulation curve and an actual test curve of efficiency of the GPS and BT/WiFi two-in-one antenna. As is illustrated in FIG. 8, it is verified through simulation and actual test that, the implementation of the GPS and BT/WiFi two-in-one antenna is feasible, and a simulation curve is relatively highly consistent with an actual test curve.

### Exemplary Embodiment 5

Efficiency of the second antenna, that is, the 5G WiFi antenna is simulated and actually tested. FIG. 9 is a comparison diagram of a simulation curve and an actual test curve of efficiency of the 5G WiFi antenna. As is illustrated in FIG. 9, it is verified through simulation and actual test that, the implementation of the 5G WiFi antenna is feasible, and a simulation curve is relatively highly consistent with an actual test curve.

In the antenna device for a mobile terminal proposed in this exemplary embodiment, the first feed point of the primary antenna is connected to the first antenna branch and the second antenna branch of the primary antenna, the first feed point is connected to the mainboard of the mobile terminal, and the second end of the second antenna branch is connected to the first metal component. Therefore, all frequency bands of 2G/3G/4G including LTE low-frequency and high-frequency/GSM/CDMA/UMTS may be covered by using only one primary antenna. Therefore, all frequency bands for global mobile phone calls may be covered, the frequency bands are wide, and the radiation efficiency is high. Moreover, for one primary antenna, the isolation problem does not need to be considered, and the costs may be further reduced.

An exemplary embodiment of another aspect of the present disclosure proposes a mobile terminal.

The mobile terminal according to this exemplary embodiment includes the antenna device according to the foregoing embodiment.

The mobile terminal may be a mobile phone, a tablet computer, or the like.

According to the mobile terminal proposed in this exemplary embodiment, all frequency bands of 2G/3G/4G including LTE low-frequency and high-frequency/GSM/CDMA/UMTS may be covered by using the antenna device according to the foregoing exemplary embodiment. Therefore, all frequency bands for global mobile phone calls may be covered, the frequency bands of the antenna device are wide, and the radiation efficiency is high. Therefore, performance of the mobile terminal is also correspondingly improved. Moreover, for one primary antenna, the isolation problem does not need to be considered, and the costs may be further reduced.

In the description of the present disclosure, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, and “circumferential” are orientations or position relationship shown based on the accompanying drawings, and are merely used for describing the present disclosure and simplifying the description, rather than indicating or implying that the apparatus or element should have a particular orientation or be constructed and operated in a particular orientation, and therefore, should not be construed as a limitation on the present disclosure.

In addition, terms “first” and “second” are used only for description objectives, and shall not be construed as indicating or implying relative importance or implying a quantity of indicated technical features. Therefore, a feature restricted by “first” or “second” may explicitly indicate or implicitly include at least one such feature. In the description of the present disclosure, unless otherwise specifically limited, “multiple” means at least two, for example, two or three.

In the present disclosure, unless explicitly specified or limited otherwise, the terms “mounted”, “connected”, “connection”, and “fixed” should be understood broadly, for example, which may be fixed connections, detachable connections or integral connections; may be mechanical connections or electrical connections; may be direct connections, indirectly connected with each other through an intermediate medium, or communications inside two elements or an interaction relationship of two elements, unless otherwise specifically limited. A person of ordinary skill in the art may understand specific meanings of the foregoing terms in this disclosure according to a specific situation.

In the present disclosure, unless explicitly specified or limited otherwise, a first characteristic “on” or “under” a second characteristic may be the first characteristic in direct contact with the second characteristic, or the first characteristic in indirect contact with the second characteristic by using an intermediate medium. Moreover, the first characteristic “on”, “above” and “over” the second characteristic may be the first characteristic right above or obliquely above the second characteristic, or only indicates that a horizontal height of the first characteristic is greater than that of the second characteristic. The first characteristic “under”, “below” and “beneath” the second characteristic may be the first characteristic right below or obliquely below the second characteristic, or only indicates that a horizontal height of the first characteristic is less than that of the second characteristic.

In the descriptions of this specification, descriptions such as reference terms “an embodiment”, “an exemplary embodiment”, “some embodiments”, “example”, “specific example”, or “some examples” intend to indicate that specific features, structures, materials, or characteristics described with reference to embodiments or examples are included in at least one embodiment or example of this disclosure. In this specification, exemplary descriptions of the foregoing terms do not necessarily refer to a same embodiment or example. In addition, the described specific feature, structure, material, or characteristic may be combined in a proper manner in any one or more embodiments or examples. In addition, with no conflict, a person skilled in the art can integrate and combine different embodiments or examples and features of the different embodiments and examples described in this specification.

Although the embodiments of the present disclosure are shown and described above, it can be understood that the foregoing embodiments are exemplary, and should not be construed as limitations to the present disclosure. A person of ordinary skill in the art can make changes, modifications, replacements, and variations to the foregoing embodiments within the scope of the present disclosure.

What is claimed is:

1. An antenna device for a mobile terminal, comprising:
a primary antenna, wherein the primary antenna is disposed on the bottom of a mobile terminal, and the primary antenna comprises:
a first antenna branch;
a second antenna branch; and
a first feed point connected to a first end of the first antenna branch and a first end of the second antenna branch, wherein the first feed point is connected to a mainboard of the mobile terminal; and
a first metal component located on the bottom of the mobile terminal, wherein the first metal component comprises a first metal segment, a second metal segment, and a third metal segment, wherein the first metal segment, the second metal segment, and the third metal segment are isolated from each other and sequentially arranged in a horizontal direction, the first metal segment and the third metal segment are connected to a metal rear case of the mobile terminal, the second metal segment has a connection point, and the connection point is connected to a second end of the second antenna branch.

2. The antenna device for a mobile terminal according to claim 1, wherein a first slot is defined between the first metal segment and the second metal segment, and a second slot is defined between the second metal segment and the third metal segment.

3. The antenna device for a mobile terminal according to claim 1, wherein the second metal segment has a first metal sub-segment and a second metal sub-segment, and the connection point is disposed between the first metal sub-segment and the second metal sub-segment, wherein the first antenna branch generates a frequency band of 2300 to 2690 MHz, the second antenna branch generates a frequency band of 699 to 960 MHz in combination with the second metal sub-segment, and the second antenna branch generates a frequency band of 1710 to 2170 MHz in combination with the first metal sub-segment.

4. The antenna device for a mobile terminal according to claim 1, further comprising: a second metal component located on the top of the mobile terminal, wherein the second metal component is isolated from the metal rear case by using a third slot and a fourth slot.

5. The antenna device for a mobile terminal according to claim 1, wherein the first antenna branch comprises:
a first structure parallel to the first metal component, wherein a first end of the first structure is connected to the first feed point;
a second structure, wherein a first end of the second structure is connected to a second end of the first structure; and
a third structure parallel to the first structure, wherein a first end of the third structure is connected to a second end of the second structure, and the length of the third structure is greater than the length of the first structure.

6. The antenna device for a mobile terminal according to claim 1, wherein the second antenna branch comprises:
a fourth structure parallel to the first metal component, wherein a first end of the fourth structure is connected to the first feed point; and
a fifth structure, wherein a first end of the fifth structure is connected to a second end of the fourth structure, and a second end of the fifth structure is connected to the connection point.

7. The antenna device for a mobile terminal according to claim 1, further comprising: a first antenna, wherein the first antenna is located on the top of the mobile terminal, the first antenna has a second feed point, and the second feed point is connected to the mainboard.

8. The antenna device for a mobile terminal according to claim 7, wherein the first antenna is a two-in-one antenna of Global Positioning System (GPS) and Bluetooth (BT)/Wireless-Fidelity (WiFi).

9. The antenna device for a mobile terminal according to claim 4, wherein the second metal component forms a multiple-input multiple-output (MIMO) antenna.

10. The antenna device for a mobile terminal according to claim 1, further comprising: a second antenna, wherein the second antenna is disposed on the mainboard.

11. The antenna device for a mobile terminal according to claim 10, wherein the second antenna is a Wireless-Fidelity (WiFi) antenna operating in a frequency band of 5150 to 5825 MHz.

12. A mobile terminal, comprising the antenna device according to claim 1.

13. The antenna device for a mobile terminal according to claim 2, wherein the second metal segment has a first metal sub-segment and a second metal sub-segment, and the connection point is disposed between the first metal sub-segment and the second metal sub-segment, wherein the first antenna branch generates a frequency band of 2300 to 2690 MHz, the second antenna branch generates a frequency band of 699 to 960 MHz in combination with the second metal sub-segment, and the second antenna branch generates a frequency band of 1710 to 2170 MHz in combination with the first metal sub-segment.

14. A mobile terminal, comprising the antenna device according to claim 2.
